(19) United States
(12) Patent Application Publication
(10) Pub. No.: US 2008/0201695 A1
(43) Pub. Date: Aug. 21, 2008

(54) COMPUTER GRAPHICS RENDERING

(76) Inventor: Qing Zhou, San Diego, CA (US)

Correspondence Address: QUALCOMM INCORPORATED, 5775 MOREHOUSE DR., SAN DIEGO, CA, 92121, US

(21) Appl. No.: 11/762,701

(22) Filed: Jun. 13, 2007

Related U.S. Application Data
(60) Provisional application No. 60/890,193, filed on Feb. 16, 2007.

(51) Int. Cl. G06F 9/45

(52) U.S. Cl. 717/136

(57) ABSTRACT

Techniques for rendering computer graphics are described. The techniques include binarization of graphics files generated using a vector graphics language (e.g., Scalable Vector Graphics (SVG)). In exemplary applications, the method is used for rendering video information in cellular phones, video game consoles, personal digital assistants (PDA), or laptop computers, among other video-enabled or audio/video-enabled wireless or wired devices.

### RELATED APPLICATIONS

This application claims the benefit of provisional U.S. Application Ser. No. 60/890,193 filed Feb. 16, 2007, which is incorporated by reference herein.

### BACKGROUND

I. Field

The present invention relates generally to the field of computer graphics and, more specifically, to techniques for rendering computer graphics.

II. Background

Graphics languages based on Extensible Markup Language (XML) and, in particular, Scalable Vector Graphics (SVG) are used in computers and mobile devices for rendering computer graphics, such as animations, mobile messengers, video games, business applications, user interfaces, and the like. During execution of the SVG-based applications, the XML serves as an interpreter language, thus forming a flexible and system-independent SVG/XML platform for rendering computer graphics.

These features made SVG, for example, a World Wide Web Consortium (W3C) standard language for the World Wide Web site. However, efficient operation of the SVG/XML graphics platform requires amounts of computational resources and energy that, in many cases, exceed capabilities of mobile devices. Despite the considerable efforts devoted to accelerating of video data processing in mobile devices, further improvements would be desirable.

### SUMMARY

Techniques for rendering computer graphics are described herein. In an embodiment, graphics files generated using a vector graphics language (for example, SVG) are converted the in C/C++ files. The C/C++ files are complied in binary-formatted files, which are executed on video-enabled devices.

In one design, the inventive method is used for rendering graphics in mobile communication, business, or entertainment devices, such as cellular phones, personal digital assistants (PDAs), laptop computers, video game consoles, audio/video-enabled devices (e.g., MP3 players), and the like.

Various aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings

### BRIEF DESCRIPTION OF THE DRAWINGS

FIG. 1 shows a flow diagram illustrating a method for rendering computer graphics.

FIG. 2 shows a high-level block diagram of an exemplary mobile video-enabled device adapted to use the method of FIG. 1.

FIG. 3 shows a high-level schematic diagram of an exemplary wireless communication system including devices of FIG. 2.

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

### DETAILED DESCRIPTION

The term “exemplary” is used herein to mean “serving as an example, instance, or illustration.” Any embodiment or design described herein as “exemplary” is not necessarily to be construed as preferred or advantageous over other embodiments or designs, and the terms “core”, “engine”, “machine”, “processor” and “processing unit” are used interchangeably.

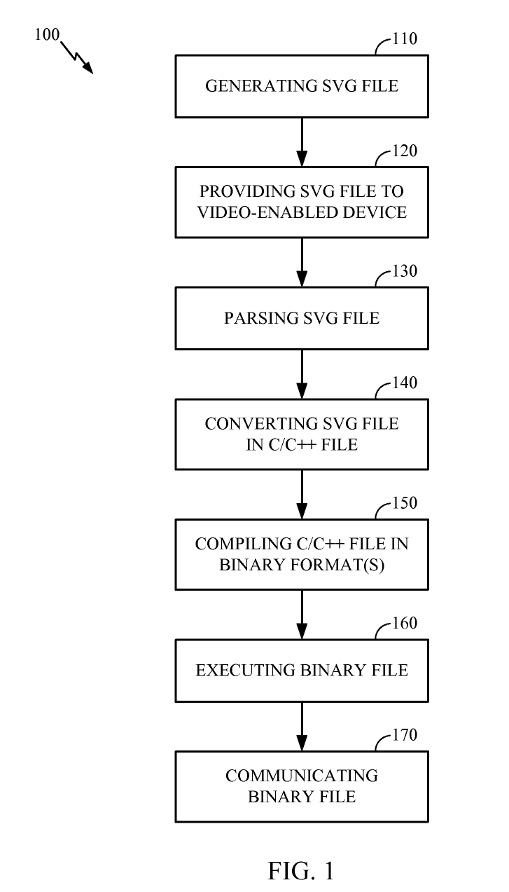

Referring to the figures, FIG. 1 depicts a flow diagram illustrating a method 100 for rendering computer graphics in accordance with one embodiment of the present invention. In exemplary applications, the method 100 may be used in cellular phones, video game consoles, personal digital assistants (PDAs), laptop computers, and video-enabled MP3 players, among other mobile (i.e., wireless) and stationary communication or video-enabled devices, for rendering various computer graphics applications, including animations, video games, user interfaces, and the like.

In various embodiments, method steps of the method 100 are performed in the depicted order, however, at least two of these steps or portions thereof may be performed contemporaneously, in parallel, or in a different order. For example, portions of steps 120 and 130 or steps 140 and 150 may be performed contemporaneously or in parallel. Those skilled in the art will readily appreciate that the order of executing at least a portion of other discussed below processes or routines may also be modified.

Hereafter, aspects of the present invention are illustratively described within the context of rendering a computer graphics program or application produced using the SVG, and the terms “SVG file” and “SVG files” are used in reference to graphics files of such programs or applications.

It will be appreciated by those skilled in the art that the invention may also be utilized within the context of graphics programs and applications produced using vector graphics languages other that the SVG. Utilization of the method 100 for rendering 2D/3D computer graphics produced using various vector graphics languages has been contemplated and is within the scope of the present invention.

At step 110, a computer graphics file is generated using a XML based vector graphics language. In one exemplary embodiment, the computer graphics file is a SVG file. Such a file may be one of a plurality of the files that, together, form a graphics program or graphics application, such as a computer video game, an animation, a business application, a user graphics interface, and the like.

The SVG file is compatible with graphics engines of the World Wide Web site and executable on many video-enabled mobile devices, including cellular phones, video game consoles, personal digital assistants (PDAs), and laptop computers, as well as various audio/video-enabled mobile devices (for example, MP3 players and the like). To date, a large library of SVG application (i.e., application programs generated using the SVG) has been developed and a number of such programs continues to grow.

At step 120, the SVG file is transmitted for execution to a respective computer terminal (for example, mobile video-enabled or audio/video-enabled device) or retrieved, for execution, from a memory of the terminal.

At step 130, the SVG file is parsed. In particular, during step 130, syntax analysis of the SVG file is performed to determine a grammar structure of the file. A parsing process transforms the SVG file is in a data structure that captures hierarchy of the SVG file and generates a concrete syntax tree of the parsed file.

At step 140, the parsed SVG file is converted in a corresponding C or C++ file. The parsed SVG may be converted in the C/C++ file using, for example, a native graphics Application Programming Interface (API) and a native event handling API. In one embodiment, step 140 utilizes an OpenVG™ API developed by a computer graphics industry consortium “Khronos Group” and a Binary Runtime Environment for Wireless (BREW) API developed by Qualcomm Inc. of San Diego, Calif. The OpenVG™ API is specifically adapted for hardware accelerated 2D vector graphics used in cellular phones and video game consoles, among other video-enabled devices.

At step 150, the C/C++ file of step 140 is compiled in at least one pre-determined binary format. In particular, the C/C++ file may be compiled in one or more binary formats executable on specific video-enabled devices. Generally, step 150 translates the source code of the inputted C/C++ file in an executable binary object code, or bytecode. A complier may be realized as a computer program residing in a memory of the respective video-enabled device.

In one embodiment, the C/C++ file is compiled using a Just-In-Time (JIT) compiler. The JIT compiles the incoming C/C++ file in a device-specific bytecode at runtime, thus increasing the execution speed of the binary object code and, as such, execution speed of the originating SVG file.

At step 160, the video-enabled device executes the binary file corresponding to the originating SVG file, thereby rendering the respective computer graphics imagery on a display of the device.

Together, software programs and, optionally, hardware means facilitating execution of steps 120, 130, 140, and 150 form a SVG binarizator of the respective video-enabled device.

At an optional step 170, the video-enabled device transmits the binary file to at least one other video-enabled device. For example, the binary file may be transmitted to a device not having the binarizator, but adapted for executing binary graphics files.

In operation, the abovementioned steps of the method 100 are sequentially repeated for all SVG files of the respective graphics application. Alternatively, at least a portion of these SVG files may be binarized contemporaneously or in parallel.

In exemplary embodiments, the method 100 may be implemented in hardware, software, firmware, or any combination thereof in a form of a computer program product comprising one or more computer-executable instructions. When implemented in software, the computer program product may be stored on or transmitted using a computer-readable medium, which includes computer storage medium and computer communication medium.

The term “computer storage medium” refers herein to any medium adapted for storing the instructions that cause the computer to execute the method. By way of example, and not limitation, the computer storage medium may comprise solid-sate memory devices, including electronic memory devices (e.g., RAM, ROM, EEPROM, and the like), optical memory devices (e.g., compact discs (CD), digital versatile discs (DVD), and the like), or magnetic memory devices (e.g., hard drives, flash drives, tape drives, and the like), or other memory devices adapted to store the computer program product, or a combination of such memory devices.

The term “computer communication medium” refers herein to any physical interface adapted to transmit the computer program product from one place to another using for example, a modulated carrier wave, an optical signal, a DC or AC current, and the like means. By way of example, and not limitation, the computer communication medium may comprise twisted wire pairs, printed or flat cables, coaxial cables, fiber-optic cables, digital subscriber lines (DSL), or other wired, wireless, or optical serial or parallel interfaces, or a combination thereof.

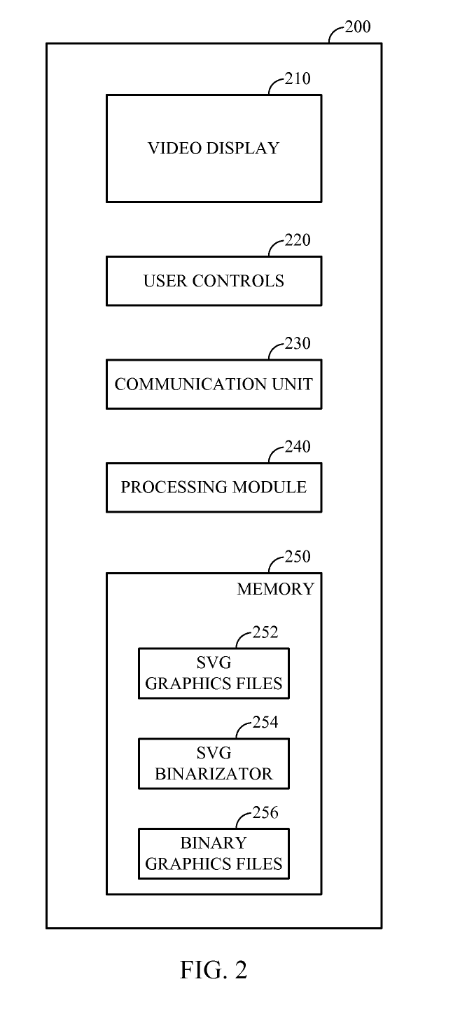

FIG. 2 shows a high-level block diagram of an exemplary mobile video-enabled device 200 adapted to use the method of FIG. 1 in accordance with one embodiment of the present invention. The device 200 illustratively comprises a display 210, user controls 220, a communication unit 230, a processing module 240, and a memory 250. In the depicted embodiment, the device 200 is a cellular phone. In other embodiments, the device 200 may be a video game console, a laptop computer, a PDA, or a video-enabled MP3 player, among other mobile or stationary video-enabled devices.

Generally, the display 210 is a graphics-enabled video display (for example, liquid crystal display (LCD)) adapted for displaying alphanumerical information, pre-determined symbols, and graphics. The user controls 220 typically includes a keypad, one or more pushbuttons, or the like actuators that enable user's interface with the device 200.

The communication unit 230 generally comprises an antenna and a transmitter/receiver module and, in operation, provides communication links to a base station of a wireless communication system or other wireless devices. In some embodiments, the communication unit 230 may also include a means for supporting wired interfaces (for example, Universal Serial Bus (USB) and the like) with external devices or computer terminals.

The processing module 240 comprises one or more microprocessors or microcontrollers and supporting digital signal processing (DSP) circuits. In operation, the processing module 240 administers operation of components of the device 200 and execution of programs and routines stored in the memory 250. Generally, the processing module 240 comprises a graphics processing unit (GPU) and is fabricated as at least one integrated circuit (IC) or a portion thereof.

The GPU may be compliant with, for example, a document “OpenVG Specification, Version 1.0,” Jul. 28, 2005, which is publicly available. This document is a standard for 2-D vector graphics suitable for handheld and mobile devices, such as cellular phones and other referred to above wireless communication apparatuses. Additionally, the GPU may also be compliant with OpenGL2.0, OpenGL ES2.0, or D3D9.0 graphics standards.

The memory 250 (for example, solid state electronic memory) generally contains application programs, user data, and system programs. Execution of the system programs activates functional features and facilitates operability of the device 200. In the depicted embodiment, the application programs include one or more programs containing SVG graphics files 252, and the system programs include a SVG binarizator 254.

In operation, the SVG binarizator 254 selectively converts the SVG graphics files 252 in binary graphics files 256 that are stored (as shown) in the memory 250 or executed on the device 200 substantially in real time.

The binary graphics files 256 are executed by the processing module 240 and their graphical content is rendered on the display 210. Optionally, the binary graphics files 256 may be forwarded, using the communication unit 230, to an external device(s) in communication with the device 200.

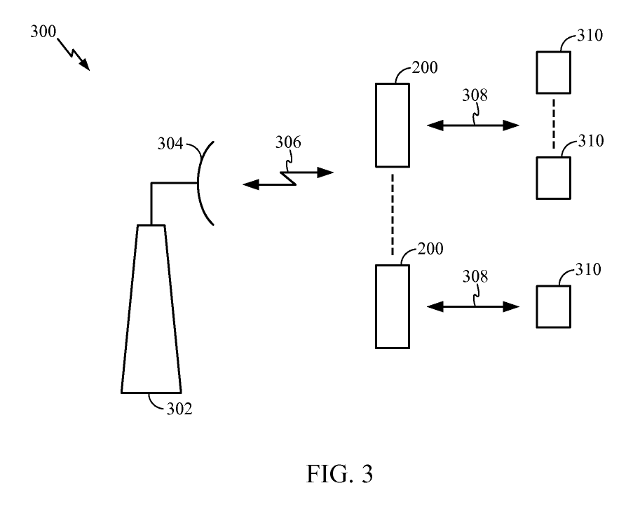

FIG. 3 shows a high-level schematic diagram of an exemplary wireless communication system 300 including devices 200 of FIG. 2 in accordance with one embodiment of the present invention.

The system 300 illustratively comprises a base station 302 having an antenna 304, a plurality of the wireless devices 200 (for example, cellular phones), and a plurality of optional devices 310 (for example, PDAs). In the depicted embodiment, the base station 302 and devices 200 are coupled using a bi-directional wireless interface 306. Correspondingly, the devices 200 and 310 are coupled using wired or wireless two-way (as shown) or one-way interfaces 308.

In some embodiments, via the interface 306, the base station 302 may transmit to a respective device 200 data messages including SVG files. In other embodiments, application programs that are pre-loaded or, alternatively, downloaded in the devices 200 using the interface 306, may contain the SVG files.

In the devices 200, the SVG files are binarized and their graphical content is rendered by executing the respective binary files. Using the interface 306, the binarized SVG files may also be transmitted to from one device 200 to other device(s) 200. Similarly, using the interfaces 308, the binarized SVG files may be transmitted to the respective devices 310.

In an alternate embodiment (not shown) wired devices 200 (for example, video game consoles) and the devices 310 may by connected to a wired network having sources of content that includes the SVG files.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An integrated circuit (IC) adapted for use in a video-enabled device, the IC comprising: a graphics processing unit (GPU) having converting means for converting a graphics file in a C/C++ file and compiling means for compiling the C/C++ file in a binary-formatted file compatible with at least one video-enabled device.

2. The integrated circuit of claim 1, wherein the converting means converts the graphics file that is generated using a vector graphics language.

3. The integrated circuit of claim 1, wherein the converting means converts the graphics file that is generated using a vector graphics language based on an Extensible Markup Language (XML).

4. The integrated circuit of claim 1, wherein the converting means converts the graphics file that is generated using a Scalable Vector Graphics (SVG) language.

5. The integrated circuit of claim 1, wherein the GPU includes means for parsing the graphics file.

6. The integrated circuit of claim 1, wherein the converting means converts the graphics file using a native graphics Application Programming Interface (API) and a native event handling API.

7. The integrated circuit of claim 1, wherein the converting means converts the graphics file using OpenVG™ Application Programming Interface (API) and Binary Runtime Environment for Wireless (BREW) API.

8. The integrated circuit of claim 7, wherein the compiling means comprises a Just-In-Time (JIT) compiler.

9. The integrated circuit of claim 1, wherein the compiling means comprises a Just-In-Time (JIT) compiler.

10. The integrated circuit of claim 1, wherein the integrated circuit is a portion of an apparatus selected from the group consisting of a cellular phone, a video game console, a personal digital assistant (PDA), a laptop computer, and an audio/video-enabled device.

11. An apparatus for rendering graphics files, comprising:
a video display;
a memory containing computer programs providing rendering of computer graphics;
a binarizator of graphics files; and
a processor for executing binary graphics files.

12. The apparatus of claim 11, wherein the binarizator converts the graphics files in the binary graphics files.

13. The apparatus of claim 11, wherein the binarizator binarizes the graphics files by parsing the graphics files generated using a Scalable Vector Graphics (SVG) language, converting the parsed files in C/C++ files, and compiling the C/C++ files in the binary-formatted files.

14. The apparatus of claim 13, wherein the binarizator converts the parsed files in the C/C++ files using OpenVG™ Application Programming Interface (API) and Binary Runtime Environment for Wireless (BREW) API.

15. The apparatus of claim 13, wherein the binarizator compiles the C/C++ files using a Just-In-Time (JIT) compiler.

16. The apparatus of claim 11, wherein the binarizator is implemented in software, hardware, or a combination thereof.

17. The apparatus of claim 11, further comprising a communication unit for receiving the graphics files or transmitting the binary-formatted files to at least one remote video-enabled device.

18. The apparatus of claim 11, wherein the apparatus is selected from the group consisting of a cellular phone, a video game console, a personal digital assistant (PDA), a laptop computer, a video-enabled device, and an audio/video-enabled device.

19. An apparatus for rendering computer graphics, the apparatus comprising: first means for converting graphics files in C/C++ files; and second means for compiling the C/C++ files in binary-formatted files.

20. The apparatus of claim 19, wherein the first means converts the graphics files that are generated using a Scalable Vector Graphics (SVG) language.

21. The apparatus of claim 19, wherein the first means includes means for parsing the graphics files.

22. The apparatus of claim 19, wherein the first means converts the graphics files in the C/C++ files using OpenVG™ Application Programming Interface (API) and Binary Runtime Environment for Wireless (BREW) API.

23. The apparatus of claim 19, wherein the second means compiles the C/C++ files using a Just-In-Time (JIT) compiler.

24. The apparatus of claim 19, wherein the apparatus is selected from the group consisting of a cellular phone, a video game console, a personal digital assistant (PDA), a laptop computer, a video-enabled device, and an audio/video-enabled device.

25. A computer program product including a computer readable medium having instructions for causing a computer processor to:
parse a graphics file;
convert the graphics file in a C/C++ file; and
compile the C/C++ file in a binary-formatted file compatible with at least one video-enabled device.

26. The computer program product of claim 25, wherein the graphics file is a Scalable Vector Graphics (SVG) language file.

27. The computer program product of claim 25, wherein the computer readable medium has instructions for causing the computer processor to: convert the graphics file using OpenVG™ Application Programming Interface (API) and Binary Runtime Environment for Wireless (BREW) API.

28. The computer program product of claim 25, wherein the computer readable medium has instructions for causing the computer processor to compile the C/C++ file using a Just-In-Time (JIT) compiler.

29. The computer program product of claim 25, wherein the computer readable medium further has instructions for causing the computer processor to execute the binary-formatted file in a wireless communication device.

30. A video-enabled device comprising a computer processor for executing instructions contained in the computer readable medium according to claim 25, wherein the video-enabled device is selected from the group consisting of a cellular phone, a video game console, a personal digital assistant (PDA), a laptop computer, and an audio/video-enabled device.

31. A method for rendering computer graphics, comprising:
parsing a graphics file generated using a Scalable Vector Graphics (SVG) language;
converting the parsed file in a C/C++ file;
compiling the C/C++ file in a binary-formatted file; and
executing the binary-formatted file on at least one video-enabled device.

32. The method of claim 31, wherein the step of converting the parsed file comprises converting the graphics file using OpenVG™ Application Programming Interface (API) and Binary Runtime Environment for Wireless (BREW) API.

33. The method of claim 31, wherein the step of compiling the C/C++ file further comprises using a Just-In-Time (JIT) compiler.

34. An apparatus for executing the method of claim 31, wherein the apparatus is selected from the group consisting of a cellular phone, a video game console, a personal digital assistant (PDA), a laptop computer, and an audio/video-enabled device.

35. A method for rendering computer graphics, comprising:
generating graphics files using a Scalable Vector Graphics (SVG) language;
parsing the graphics files;
converting the parsed graphics files in C/C++ files; and
compiling the C/C++ files in binary-formatted files.

36. The method of claim 35, wherein the converting step comprises using an OpenVG™ Application Programming Interface (API) and a Binary Runtime Environment for Wireless (BREW) API to convert the parsed graphics files.

37. The method of claim 35, wherein the compiling step comprises using a Just-In-Time (JIT) compiler to compile the C/C++ files.

38. An apparatus adapted for executing the method of claim 35, wherein the apparatus is selected from the group consisting of a cellular phone, a video game console, a personal digital assistant (PDA), a laptop computer, and an audio/video-enabled device.
